(19) United States
(12) Patent Application Publication
(10) Pub. No.: US 2012/0166007 A1
(43) Pub. Date: Jun. 28, 2012

(54) METHOD AND SYSTEM FOR INTEGRAL ENERGY MANAGEMENT OF BUILDINGS

(75) Inventors: Youn Kwae JEONG, Daejeon (KR); Wan Ki Park, Daejeon (KR); Jinsoo Han, Daejeon (KR); Chang-Sie Choi, Daejeon (KR); Hyun Jin Yoon, Daejeon (KR); Il Woo Lee, Daejeon (KR)

(73) Assignee: Electronics and Telecommunications Research Institute, Daejeon (KR)

(21) Appl. No.: 13/330,179

(22) Filed: Dec. 19, 2011

(30) Foreign Application Priority Data
Dec. 23, 2010 (KR) 10-2010-0134079

(51) Int. Cl. G06F 1/32

(52) U.S. Cl. 700/295

(57) ABSTRACT

An EMM (Energy Monitoring and Management) control system performs energy management of buildings, each building having an EMM client disposed therein. The EMM control system includes an EMM server configured to receive operation information of energy-consuming equipments in the building and information related to energy and environment of the building from the EMM client to perform a function of analyzing/taking statistics/reporting for the operation information, and energy and environment information, an EOM (Energy Optimization and Maintenance) server configured to derive an optimum energy operation program through energy evaluation index and simulation from the information provided from the EMM client and providing the optimum energy operation program to the EMM client.

### CROSS-REFERENCE TO RELATED APPLICATION(S)

The present invention claims priority of Korean Patent Application Nos. 10-2010-0134079, filed on Dec. 23, 2010, which is incorporated herein by reference.

### FIELD OF THE INVENTION

The present invention relate to energy management of buildings, and more particularly, to a system and method for remotely monitoring energy consumption for a plurality of buildings and efficiently deriving optimum energy operation environment of the buildings based on the monitored information.

### BACKGROUND OF THE INVENTION

At present, buildings provides with energy-consuming equipments, for example, heating, ventilation and air condition (HVAC), lighting equipment, emergency equipment, and/or security equipment, a communication network for controlling and monitoring the energy-consuming equipments, energy sensing and metering equipments collecting a state and energy consumption data of the energy-consuming facilities, or a system controlling the energy-consuming equipments by an operator in each building based on the collected state and energy consumption data of the energy-consuming equipments.

However, even though a system for energy management of the respective building is built, energy experts are not present in the buildings, and thus there is still in a simple operation for each building. That is, even though the buildings have equipments capable of saving energy consumption, an operation for optimizing the usage and efficiency of the system may not be performed. In addition, since there is a need to secure the energy expert for operating the system for each building, the operation costs for energy management of buildings may be increased. Further, there are no methods for effectively managing buildings at remote location capable of integrating and operating an energy-related system of various buildings having different forms at remote location.

### SUMMARY OF THE INVENTION

In view of the above, the present invention provides a system and method for integrally monitoring and managing energy consumption of buildings at remote location.

In accordance with a first aspect of the present invention, there is provided an EMM (Energy Monitoring and Management) client for energy management of a building, the EMM client disposed in a building and connected to a EMM control system at remote location over a network, comprising:

an operation information collection unit configured to collect operation information of energy-consuming equipments in the building;

an environment information collection unit configured to collect environment information generated from environment sensors in the building;

a user interface unit configured to input an operation plans of the building;

an interworking interface unit configured to interwork with the EMM control system voer the network;

a data processing unit configured to process the information provided from the operation information collection unit, the environment information collection unit, and the user interface unit and transmitting the processed data to the EMM control system through the interworking interface unit and receiving an optimum energy operation program from the EMM control system; and

an equipment control unit controlling the energy-consuming equipments in conformity with the optimum energy operation program.

In accordance with a second aspect of the present invention, there is provided an EMM (Energy Monitoring and Management) control system for energy management of buildings, each building having an EMM client disposed therein, the EMM control system comprising:

an EMM server configured to receive operation information of energy-consuming equipments in the building and information related to energy and environment of the building from the EMM client to perform a function of analyzing/taking statistics/reporting for the operation information, and energy and environment information;

an EOM (Energy Optimization and Maintenance) server configured to derive an optimum energy operation program through energy evaluation index and simulation from the information provided from the EMM client and providing the optimum energy operation program to the EMM client.

In accordance with a third aspect of the present invention, there is provided a system for integral energy management of buildings over a network, the system comprising:

a plurality of EMM (Energy Monitoring and Management) clients disposed in the buildings, respectively, each EMM client configured to collect information related to energyx, energy-consuming equipments, environment in the building; and

an EMM control system configured to derieve optimum energy operation programs for the respective buildings from the information provided from the EMM clients through the network, wherein the derieved optimum energy operation programs are transmitted to the corresponding EMM clients and the EMM clients operate the energy-consuming equipments in conformity with the optimum energy operation programs, respectively.

In accordance with a fourth aspect of the present invention, there is provided a system for integral energy management of buildings over a network, the system comprising:

a plurality of EMM (Energy Monitoring and Management) clients disposed in the buildings, respectively, each EMM client configured to collect information related to energyx, energy-consuming equipments, environment in the building; and

an EMM control system configured to derieve optimum energy operation modes for the respective buildings from the information provided from the EMM clients through the network, wherein the derieved optimum energy operation modes are transmitted to the corresponding EMM clients and the EMM clients operate the energy-consuming equipments in conformity with the optimum energy operation modes, respectively.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic block diagram of a system for integrally monitoring and managing energy consumption of buildings at remote location in accordance with an embodiment of the present invention;

FIG. 2 is a detailed block diagram of each EMM client shown in FIG. 1;

FIG. 3 is a detailed block configuration diagram of an EMM control system shown in FIG. 1;

FIG. 4 is a flowchart illustrating a process performed by the EMM client in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art. Throughout the disclosure, like reference numerals refer to like parts throughout the various figures and embodiments of the present invention.

FIG. 1 illustrates a schematic block diagram of a system for integrally monitoring and managing energy consumption of buildings at remote location in accordance with an embodiment of the present invention.

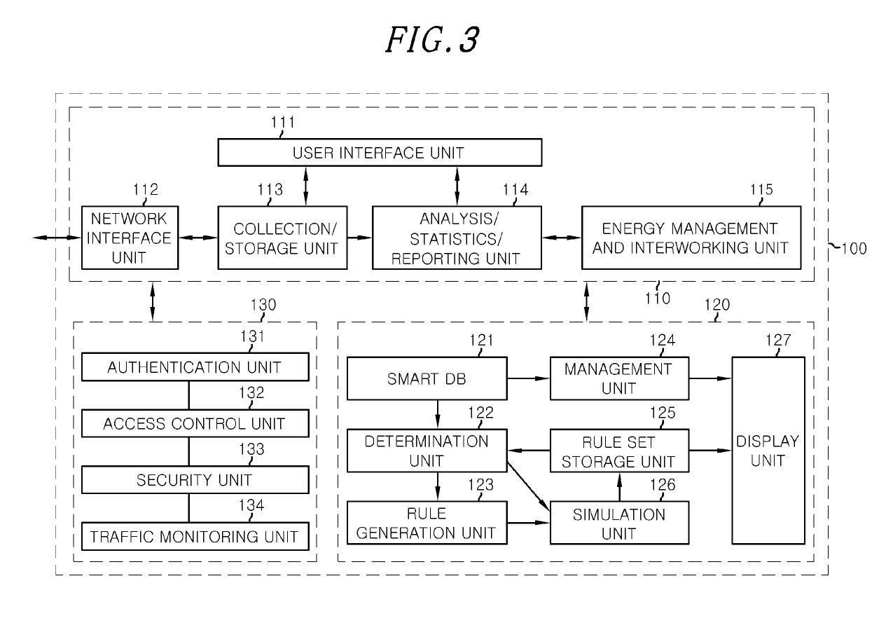

As illustrated in FIG. 1, a system for integrally monitoring and managing energy consumption of buildings at remote location includes a plurality of energy monitoring and management (EMM) clients 200 disposed in each building and an EMM control system 100 which is connected with each EMM client 200 through a network 150 at remote location. The building control system is configured to manage building energy by controlling the EMM clients 200 disposed in the respective building. The EMM control system 100 includes an EMM server 110, an EOM (Energy Optimization and Maintenance) server 120 and an ESC (Energy Security Convergence) server 130, which will be discussed with reference with FIG. 3.

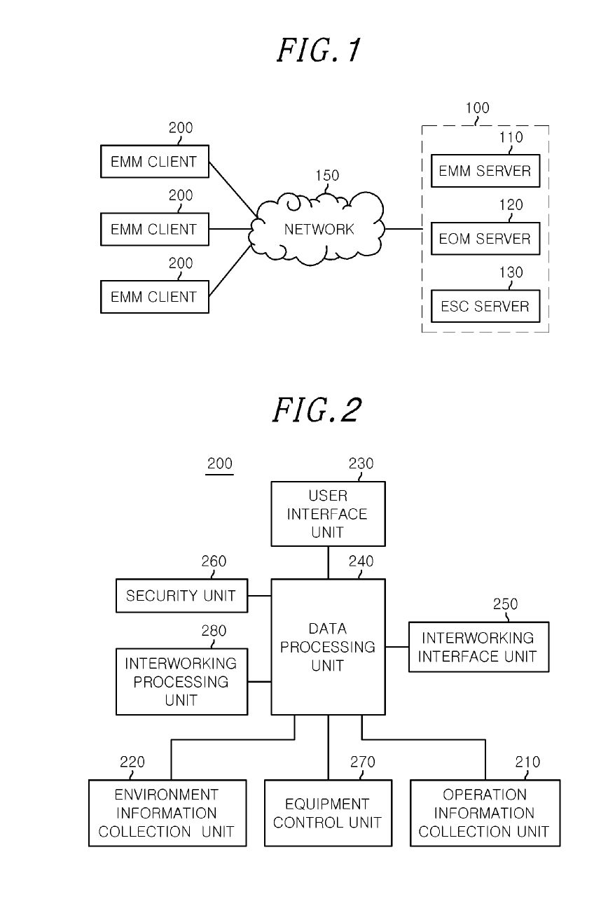

FIG. 2 is a detailed block diagram of the EMM client shown in FIG. 1.

As illustrated in FIG. 2, the EMM client 200 includes an energy-related information collection unit 210, an environment information collection unit 220, a user interface unit 230, a data processing unit 240, an interworking interface unit 250, a security unit 260, an equipment control unit 270, and an interworking processing unit 280.

The operation information collection unit 210 collects operation information of energy-consuming equipments disposed in a building, for example, HAVC (heating, ventilation, and air conditioning), light equipment, emergency equipment, and security equipments through the use of, for example, BAM (Building Automation System).

The environment information collection unit 220 collects environment information of the building such as temperature, humidity, air quality, and the like, at each position of the building based on a sensor network infrastructure built in the building and building information related to the building.

The user interface unit 230 provides an interface for inputting contents such as operation plans of the building, a user demand, or the like. Through the use of the user interface, a user, e.g., building manager reflects the operation plans of the building or his/her own demand to the EMM client 200.

The data processing unit 240 processes information collected by the operation information collection unit 210 and the environment information collection unit 220 and information input through the user interface unit 230. The processed information is transmitted to the EMM control system 100 through the interworking interface unit 250. Further, the data processing unit 240 provides a data and service matching middleware function that matches data formats and meanings for the operation information of the energy-consuming equipments, energy consumption information, environment information, and energy management services in the building with information and services processed and managed in the EMM control system 100. That is, the data processing unit in each EMM client allows using a unified interface and protocol between the EMM clients and the EMM control system. In addition, the data processing unit 240 receives an optimum energy operation mode from the EMM control system 100 and provides the optimum energy operation program to the equipment control unit 270.

The interworking interface unit 250 controls a connection with the EMM control system 100.

The security unit 260 undertakes the security and safety with respect to information collected by the operation information collection unit 210 and the environment information collection unit 220 and the information input through the user interface unit 230. In order words, the security unit 260 authenticates a user accessing the EMM client 200 through any authentication scheme using, for example, biometrics, ID/password, or an ID card and permits the access of the user to the EMM client 200. The equipment control unit 270 controls building energy in accordance with the building operation plans provided through the user interface unit 230.

The interworking processing unit 280 interworks with a smart grid managing new renewable energy in the building to process the energy management of the building.

Meanwhile, the EMM control system 100 determines an optimum energy operation program for the building based on the information provided from the EMM client 200 and provides the optimum energy operation program to the EMM client 200 through the network 150. In this case, the optimum energy operation program includes an energy saving measure of the building and an operation measure for the energy-consuming equipments in the building. In this connection, the EMM client 200 provides an interface to display the optimum energy operation program through the user interface unit 230 so that the building manager is aware of the information related to the optimum energy operation program or determine permission or rejection of the optimum energy operation program.

In addition, when improvements or problems in the operation plan of building are recognized based on the information provided from the EMM client 200, the EMM control system 100 provides the improvements and the problems to the EMM clients 200. Upon receiving the improvements or the problems of the above-mentioned operation plan, the EMM client 200 may correct the operation plan of the building and then enters an idle or monitoring mode to continuously monitor the corrected operation plan and provide the monitored information to the EMM control system 100 through the network 150.

FIG. 3 is a detailed block configuration diagram of the EMM control system illustrated in FIG. 1.

As described above, the EMM control system 100 includes the EMM server 110, the EOM server 120 and the ESC server 130. The EMM server 110 performs a function of collecting and storing operation information of the energy-consuming equipments in the building, energy and environment information in the building, and analyzing/taking statistics/reporting for the operation information, and energy and environment information. The EMM server 110 includes a user interface unit 111, a network interface unit 112, a collection/storage unit 113, an analysis/statistics/reporting unit 114, and an energy management and interworking unit 115.

The EOM server 120 derives an optimum energy operation program such as an energy saving schemes and/or a building operation plans through an energy evaluation index or simulation from the information provided by the EMM client 200 and provides the derived optimum energy operation program to the EMM client 200. To this end, the EOM server 120 performs a database management function of energy information for each attribute of the building such as, for example, a size, a material, a shape, etc of the building, a determination function inclusive of inference function for the energy operation based on the databased energy information, a rule generation function for generating building energy management rule such as an energy saving measure, a storage function of the generated building energy management rule, a simulation function for verifying the generated building energy management rule, a matching function for displaying an energy management measure and an equipment management measure. The EOM server 120 include a smart DB 121, a determination unit 122, a rule generation unit 123, a management unit 124, a rule set storage unit 125, a simulation unit 126, and a display unit 128.

The ESC server 130 performs a security function including a user authentication for system protection and prevention of illegal intrusion to the EMM control system 100, an access control for each service, security networking, and traffic surveillance and monitoring. To this end, the ESC server 130 includes an authentication unit 131, an access control unit 132, a security unit 133, and a traffic monitoring unit 134.

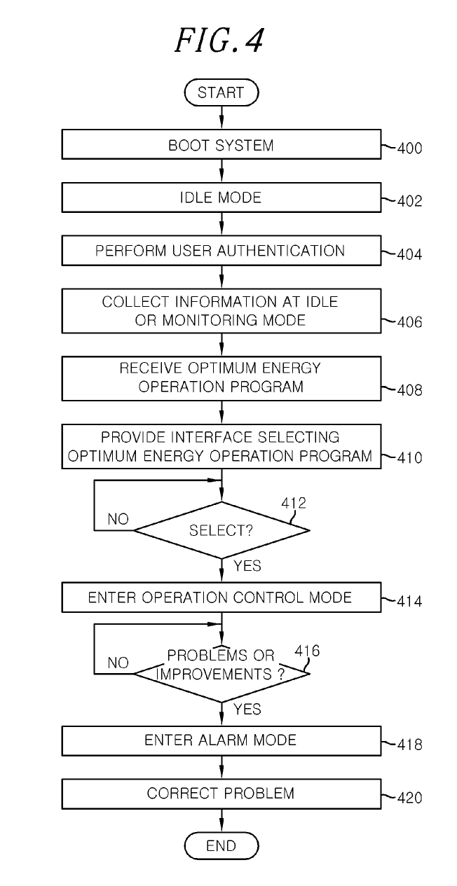

FIG. 4 is a flow chart illustrating a process performed by the EMM client in accordance with an embodiment of the present invention.

First of all, the EMM client 200 performs system booting for a system operation in step 400 and enters the idle mode in step 402.

Next, when there is an access request of a user, for example, a building manager, the EMM client 200 performs an authentication of the user through the security unit 260 to permit the access of the authorized user in step 404.

Thereafter, in step 406, the EMM client 200 enters the idle or monitoring mode to transmit the information provided from the operation information collection unit 210, the environment information collection unit 220, and the user interface unit 230 to the EMM control system 100. Herein, the information provided to the EMM control system 100 includes the operation information of energy-consuming equipments from the operation information collection unit 210, the building environment and the energy information from the environment information collection unit 220, and the user demand or the building operation plans for the building input through the user interface unit 230.

In step 408, the EMM control system 100 then generates the optimum energy operation program based on the information provided from the EMM client 200.

Thereafter, in step 410, the EMM client 200 receives the optimum energy operation program from the EMM control system 100 and then provides the user interface for selecting permission or rejection option of the optimum energy operation program provided from the EMM control system 100 through the user interface unit 230.

Thereafter, when the user selects the permission option of the optimum energy operation program in step 412, the EMM client 200 controls the equipment control unit 270 to enter an operation control mode initiating the building operation based on the optimum energy operation program.

Meanwhile, in step 416, when the EMM control system 100 receives the information provided from the EMM client 200, the EMM control system 100 draws the improvements or the problems of the building operation to provide the improvements or problems to the EMM client 200.

In response thereto, in step 418, the EMM client 200 enters an alarm informing mode to provide the improvements or the problems to the user.

Next, the user confirms the problems or the improvements and may then correct the problems through the control of the EMM client 200 in step 420.

As set forth above, the embodiment of the present invention can build the integrated management environment for a plurality of buildings at remote locations and can integrally propose and integrally manage the operation measures for the energy-consuming equipment in the respective buildings under the integrated management environment for the buildings. In addition, the embodiment of the present invention can provide the integral building management method for optimum energy management based on the energy-consuming equipment, energy, and environment information of the respective buildings at the EMM control system through the interworking with the EMM clients in the respective buildings.

While the present invention has been described with respect to the specific embodiments, it will be apparent to those skilled in the art that various changes and modifications may be made without departing from the scope of the invention as defined in the following claims.

What is claimed is:

1. An EMM (Energy Monitoring and Management) client for energy management of a building, the EMM client disposed in a building and connected to a EMM control system at remote location over a network, comprising:
an operation information collection unit configured to collect operation information of energy-consuming equipments in the building;
an environment information collection unit configured to collect environment information generated from environment sensors in the building;
a user interface unit configured to input an operation plans of the building;
an interworking interface unit configured to interwork with the EMM control system voer the network;
a data processing unit configured to process the information provided from the operation information collection unit, the environment information collection unit, and the user interface unit and transmitting the processed data to the EMM control system through the interworking interface unit and receiving an optimum energy operation program from the EMM control system; and
an equipment control unit controlling the energy-consuming equipments in conformity with the optimum energy operation program.

2. The EMM client of claim 1, wherein the EMM client receives problems and/or improvements related to the building operation from the EMM control system.

3. The EMM client of claim 1, wherein the EMM client includes a interworking processing unit that interworks with a smart grid managing new renewable energy in the building to effectively process the energy management of the building.

4. The EMM client of claim 1, wherein the EMM client further comprises a security unit configured to perform an authentication that determines whether to permit a user access to the EMM client.

5. The EMM client of claim 1, wherein the EMM client further comprises a user interface unit configured to provide an interface to select permission or rejection option of the optimum energy operation program.

6. The EMM client of claim 1, wherein the data processing unit is further configured to provide a data and service matching middleware function that matches formats and meanings for operation information related to operation environment for each energy-consuming equipment, energy information, environment sensor information, and energy management services to be similarly processed and managed in the EMM control system.

7. An EMM (Energy Monitoring and Management) control system for energy management of buildings, each building having an EMM client disposed therein, the EMM control system comprising:
an EMM server configured to receive operation information of energy-consuming equipments in the building and information related to energy and environment of the building from the EMM client to perform a function of analyzing/taking statistics/reporting for the operation information, and energy and environment information;
an EOM (Energy Optimization and Maintenance) server configured to derive an optimum energy operation program through energy evaluation index and simulation from the information provided from the EMM client and providing the optimum energy operation program to the EMM client.

8. The EMM control system of claim 7, wherein the EMM control system is includes a security management apparatus performing a function of user authentication, access control for each service, security network, traffic surveillance and monitoring at the time of communication with the EMM client.

9. The EMM control system of claim 7, wherein the EMM server includes:
a network interface unit configured to communicate with the EMM client;
an information collection and storage unit configured to collect and store the energy and environment information provided from the EMM client;
an energy management and interworking unit configured to interwork with the EOM server;
an analysis/statistics/reporting unit configured to perform analysis, statistics, or reporting functions based on the energy information related to the energy; and
an interface unit configured to provide an interface between a user and the EMM server.

10. The EMM control system of claim 7, wherein the EOM server includes:
a management unit configured to perform of databasing, storing, and managing the energy information for each attribute of the building;
a determination unit configured to determine an energy operation state of the building based on the databased energy information;
a rule generation unit configured to generate a an energy management rule of the building;
a simulation unit configured to verify the energy management rule; and
a display unit configured to display an energy management measure and an equipment management measure.

11. The EMM control system of claim 7, wherein the EOM server is further configured to draw problems and/or improvements of the building operation based on the information provided from the EMM client.

12. A system for integral energy management of buildings over a network, the system comprising:
a plurality of EMM (Energy Monitoring and Management) clients disposed in the buildings, respectively, each EMM client configured to collect information related to energyx, energy-consuming equipments, environment in the building; and
an EMM control system configured to derieve optimum energy operation programs for the respective buildings from the information provided from the EMM clients through the network, wherein the derieved optimum energy operation programs are transmitted to the corresponding EMM clients and the EMM clients operate the energy-consuming equipments in conformity with the optimum energy operation programs, respectively.

13. A method for integral energy management of buildings by an EMM (Energy Monitoring and Management) control system over a network, each building having an EMM client disposed therein to manage energy in the building, comprising:
collecting information related to building operation in the EMM clients;
transmitting the information from the EMM clients to the EMM control system through the network;
deriving optimum energy operation programs for the buildings based on the information from the EMM clients; and
controlling the energy-consuming equipments in the buildings in conformity with the optimum energy operation programs, respectively.

14. The method of claim 13, further comprising:
performing an authentication by the respective EMM clients that determines whether to permit an access to the respective EMM clients.

15. The method of claim 13, wherein said collecting information related to the building operation comprises collecting information related to energy-consuming equipments, energy, and environment in the buildings.

16. The method of claim 13, further comprising:
providing problems and/or improvements related to the building operations for the buildings by the EMM control system;
operating an alarm informing mode informing the problems and/or the improvements to the user of the buildings by the EMM clients, respectively; and
correcting the building operation for the buildings by the EMM clients, respectively, in accordance with the problems and/or the improvements.
